(19) United States
(12) Patent Application Publication
(10) Pub. No.: US 2008/0139049 A1
(43) Pub. Date: Jun. 12, 2008

(54) Electrical connector having a sheel

(75) Inventors: Toshio Masumoto, Tokyo (JP); Kan Ozawa, Tokyo (JP); Minoru Urano, Tokyo (JP); Fumio Yaguchi, Tokyo (JP)

Correspondence Address: COLLARD & ROE, P.C., 1077 NORTHERN BOULEVARD, ROSLYN, NY, 11576, US

(73) Assignee: Japan Aviation Electronics Industry, Limited

(21) Appl. No.: 11/985,874

(22) Filed: Nov. 16, 2007

(30) Foreign Application Priority Data
Dec. 7, 2006 (JP) 2006-331082
Feb. 15, 2007 (JP) 2007-35265

(51) Int. Cl. H01R 13/648

(52) U.S. Cl. 439/607

(57) ABSTRACT

A shell covering a housing has a shell body portion and a first and a second joining portion joining both ends of the shell body portion to each other. The first joining portion has a projecting portion projecting from a first end portion of the shell body portion and a recessed portion formed at a second end portion of the shell body portion and engaging with the projecting portion. The second joining portion has a first overlapping portion and a second overlapping portion that are overlapped with each other. The first overlapping portion is part of the first end portion and the second overlapping portion is part of the second end portion. An opening is formed at the first overlapping portion and a caulking portion is formed at the second overlapping portion. The opening and the caulking portion engage with each other by caulking the caulking portion.

This application is based upon and claims the benefit of priority from Japanese patent applications No. 2006-331082, filed on Dec. 7, 2006 and No. 2007-35265, filed Feb. 15, 2007, the disclosures of which are incorporated herein in their entirety by reference.

### BACKGROUND OF THE INVENTION

This invention relates to an electrical connector having a shell fitted over a housing.

As related art, Japanese Utility Model Registration No. 2593552 (JP-Y) (Patent Document 1) describes an outer conductor of a coaxial connector, which is formed into a hollow cylindrical shape by bending a metal plate.

The outer conductor is formed by bending the metal plate and butting and joining both end sides thereof together. One of the end sides of the metal plate has a dovetailed projecting portion with a widened end and the other end side has a corresponding cutout portion, wherein the dovetailed projecting portion is fitted into the cutout portion with no space therebetween so that both are joined together. The outer conductor has portions applied with a crushing process near the end sides of the metal plate.

On the other hand, as another related art, Japanese Patent No. 3803837 (JP-B) (Patent Document 2) describes an electrical connector having a metal shell fitted over a housing.

The shell is formed by bending a metal plate into a hollow rectangular parallelepiped. Both end portions of the metal plate are overlapped with each other to form a joined portion at the bottom of the shell. The thickness of the joined portion is substantially equal to that of the other part of the metal plate.

One of the end portions of the metal plate is pressed to a thickness half that of the metal plate to thereby form a stepped joining edge portion and the other end portion is also pressed to a thickness half that of the metal plate to thereby form a stepped joining edge portion. These joining edge portions are overlapped and joined together to form the joined portion.

In Patent Document 1, the thickness of each of the end sides of the metal plate is equal to that of the other part of the metal plate. Therefore, there is a problem that when the outer conductor is required to have a greater strength against a load such as a pinch force, the coaxial connector cannot ensure a structurally sufficient strength.

In Patent Document 2, the thickness of each of the joining edge portions of the metal plate is half that of the other part of the metal plate. Therefore, since the thickness of the joined portion is equal to that of the other part of the metal plate, there is a problem that it is not possible to obtain a structurally sufficient strength required for the shell.

Further, in Patent Document 2, since both end portions of the metal plate are each pressed to the thickness half that of the other part of the metal plate by a crushing process, there is a problem that the shape and material are limited.

### SUMMARY OF THE INVENTION

It is therefore an object of this invention to provide an electrical connector that can improve the strength of a joined portion of a shell.

According to this invention, there is provide an electrical connector comprising a contact, a housing holding said contact, and a shell covering said contact and said housing,

wherein said shell comprises a shell body portion and a joining portion joining both ends of said shell body portion to each other,

said joining portion comprises a first joining portion and a second joining portion,

said first joining portion comprises a projecting portion projecting from a first end portion and a recessed portion formed at a second end portion (33f) and engaging with said projecting portion,

said second joining portion comprises a first overlapping portion and a second overlapping portion that are overlapped with each other, said first overlapping portion being part of said first end portion and said second overlapping portion being part of said second end portion,

an opening is formed at one of said first and second overlapping portions and a caulking portion is formed at the other of said first and second overlapping portions, and

said caulking portion is inserted in said opening and caulked, so that said opening and said caulking portion engage with each other.

### BRIEF DESCRIPTION OF THE DRAWINGS

FIG. 1 is a front view showing an electrical connector of a first embodiment according to this invention;

FIG. 2 is a bottom view of the electrical connector shown in FIG. 1;

FIG. 3 is a right side view of the electrical connector shown in FIG. 1;

FIG. 4 is a right side sectional view of the electrical connector shown in FIG. 1, wherein the electrical connector is shown with its attaching portion being omitted and is partly sectioned;

FIG. 5 is a plan view of the electrical connector shown in FIG. 1;

FIG. 6 is a bottom view enlargedly showing an overlapped portion of the electrical connector shown in FIG. 2;

FIG. 7 is a sectional view taken along line A-A in FIG. 6;

FIG. 8 is a sectional view taken along line B-B in FIG. 6;

FIG. 9 is a sectional view showing an electrical connector of a second embodiment according to this invention, wherein there is shown a modification of the overlapped portion shown in FIGS. 6 to 8;

FIG. 10 is a sectional view showing an electrical connector of a third embodiment according to this invention, wherein there is shown a modification of the overlapped portion shown in FIGS. 6 to 8;

FIG. 11 is a perspective view showing an end portion of a second joining plate portion and a caulking portion shown in FIG. 10;

FIG. 12 is a sectional view showing an engaged state of an overlapped portion of the electrical connector shown in FIG. 10;

FIG. 13 is a sectional view showing an electrical connector of a fourth embodiment according to this invention, wherein there is shown a modification of the overlapped portion shown in FIGS. 6 to 8; and

FIG. 14 is a perspective view showing an end portion of a second joining plate portion and a caulking portion shown in FIG. 13.

### DESCRIPTION OF THE PREFERRED EMBODIMENTS

### First Embodiment

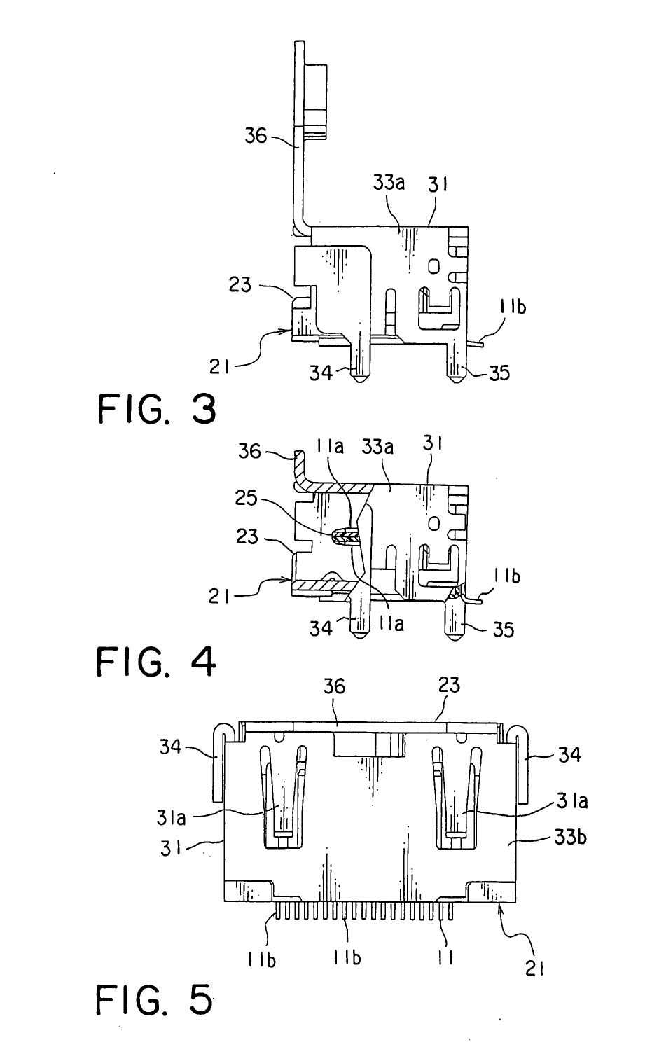

FIGS. 1 to 5 show a connector of a first embodiment according to this invention. Referring to FIGS. 1 to 5, the connector comprises conductive contacts 11, an insulating housing 21 holding the contacts 11, and a metal shell 31 covering the outside of the housing 21.

The contacts 11 are each formed by applying bending to a belt-like metal plate. The contacts 11 are arranged at regular intervals and incorporated into the housing 21.

The housing 21 is formed of a resin material. The housing 21 comprises a generally rectangular parallelepiped housing body 23 and a plate-like fitting portion 25 formed on a surface 23a of the housing body 23 so as to project therefrom.

Contact portions 11a on one end side of the contacts 11 are disposed on an upper surface and a lower surface, opposed thereto, of the fitting portion 25. As shown in FIGS. 1 and 4, the contact portions 11a are aligned in a row on the upper surface of the fitting portion 25 and, likewise, the contact portions 11a are aligned in a row on the lower surface of the fitting portion 25. Accordingly, the contact portions 11a are arranged in two rows on the upper and lower surfaces of the fitting portion 25.

The fitting portion 25 is fitted to a mating fitting portion of a mating connector (not shown) serving as a plug side. The mating fitting portion is provided with mating contact portions of mating contacts to which cables (not shown) are connected. The contact portions 11a and the mating contact portions are connected together when the fitting portion 25 and the mating fitting portion are fitted together.

From another surface, opposed to the surface 23a, of the housing body 23, terminal portions 11b of the contacts 11 extend out to the exterior of the housing body 23. After the connector is mounted on a printed circuit board 51 shown in FIG. 1, the terminal portions 11b are connected to a signal transmission circuit of the printed circuit board 51 by soldering.

The shell 31 comprises a shell body portion 33 formed into a generally hollow rectangular parallelepiped shape and a pair of first leg portions 34 provided continuously to an open side of the shell body portion 33 at its one end. The shell 31 further comprises a pair of second leg portions 35 each provided continuously to a corresponding one of a pair of side plate portions 33a of the shell body portion 33, and an attaching portion 36 connected to an upper plate portion 33b of the shell body portion 33.

Each first leg portion 34 is bent so as to face an outer surface of the corresponding side plate portion 33a and extends downward more than the shell body portion 33. Each second leg portion 35 projects outward from the corresponding side plate portion 33a. A tip portion of each second leg portion 35 also extends downward more than the shell body portion 33. The attaching portion 36 extends upward in a direction perpendicular to the upper plate portion 33b.

The first and second leg portions 34 and 35 are inserted into insertion holes (not shown) formed in the printed circuit board 51 shown in FIG. 1 so as to be connected to a ground circuit (not shown) of the printed circuit board 51. The attaching portion 36 is attached to a case of a device (not shown) for ground connection.

The shell body portion 33 is attached to the housing body 23 so as to surround the outer periphery of the housing body 23. That is, the shell body portion 33 has the pair of side plate portions 33a, the upper plate portion 33b, and a pair of first and second joining plate portions 33c and 33d.

Each side plate portion 33a of the shell body portion 33 is located outside a corresponding one of a pair of side surfaces 23d, opposed to each other, of the housing body 23. An upper surface 23f of the housing body 23 is opposed to a lower surface 23g of the housing body 23. The upper plate portion 33b of the shell body portion 33 is located outside the upper surface 23f of the housing body 23. The first and second joining plate portions 33c and 33d are opposed to the upper plate portion 33b of the shell body portion 33. Further, the first and second joining plate portions 33c and 33d are located so as to face the lower surface 23g of the housing body 23.

Normally, the shell 31 is formed by conveying a metal plate, prepared in the form of a roll, into a press machine and bending the metal plate into a generally hollow rectangular parallelepiped shape by the press machine to obtain the shell body portion 33. The shell body portion 33 requires a joining portion joining together an end portion 33e of the first joining plate portion 33c and an end portion 33f of the second joining plate portion 33d at the position just under the lower surface 23g of the housing body 23.

The joining portion comprises a first joining portion and a second joining portion.

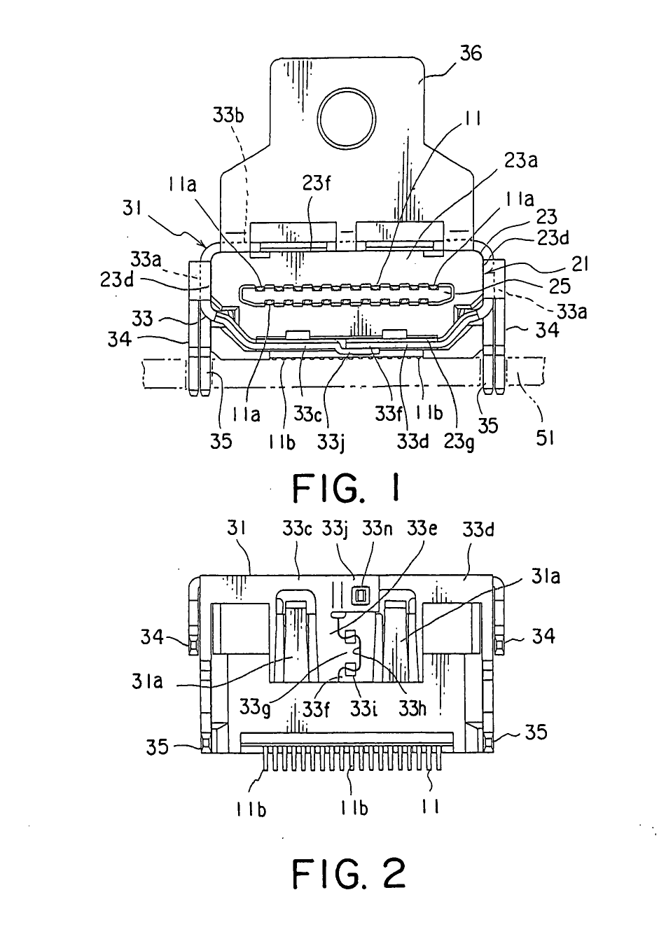

As shown in FIG. 2, the first joining portion comprises a projecting portion 33g formed so as to project outward from an edge of the end portion 33e of the first joining plate portion 33c. The first joining portion further comprises a recessed portion (cutout portion) 33h formed at an edge of the end portion 33f of the second joining plate portion 33d so as to engage with the projecting portion 33g. The projecting portion 33g and the recessed portion 33h engage with each other so that the edges of the first and second joining plate portions 33c and 33d are butted to each other to make the plate surfaces of the first and second joining plate portions 33c and 33d flush with each other.

It is expected that a large clearance is formed at a butted portion between the projecting portion 33g and the recessed portion 33h. In this event, at the butted portion between the projecting portion 33g and the recessed portion 33h, crushed portions 33i are formed by crushing portions of the first and second joining plate portions 33c and 33d so as to bridge across the projecting portion 33g and the recessed portion 33h. When the crushed portions 33i are formed, the projecting portion 33g and the recessed portion 33h are partially pushed out between the projecting portion 33g and the recessed portion 33h by the crushing process. Since this makes it possible to minimize the clearance at the butted portion between the projecting portion 33g and the recessed portion 33h, it is possible to increase the joining strength of the shell body portion 33.

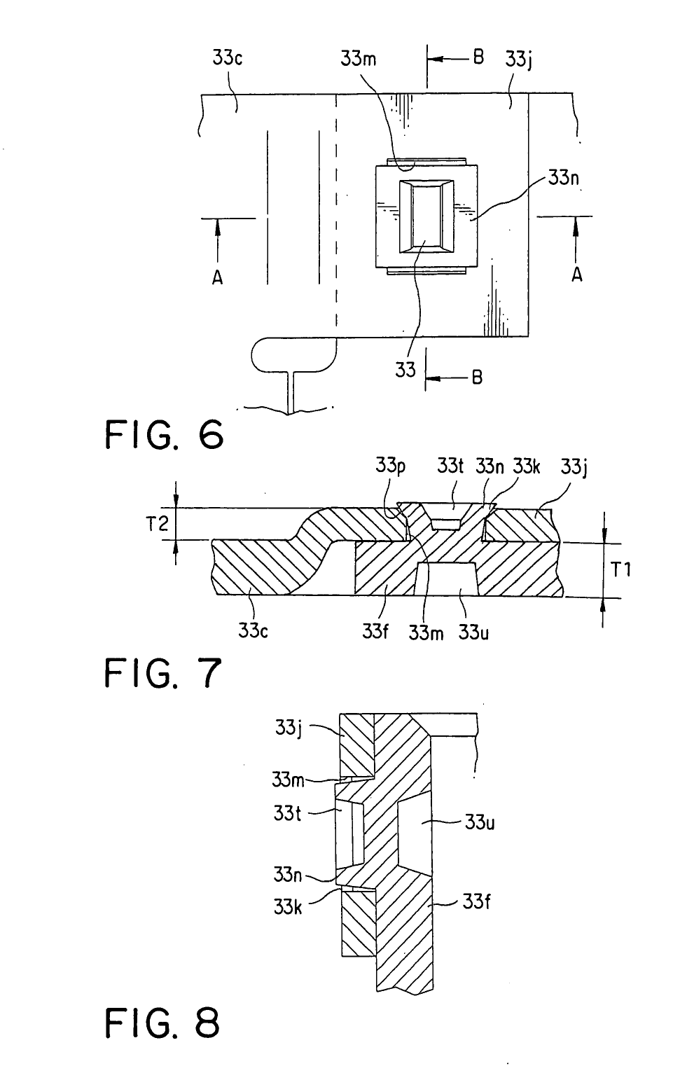

FIG. 6 is a bottom view enlargedly showing an overlapped portion of the electrical connector shown in FIG. 2. FIG. 7 shows a section taken along line A-A in FIG. 6 and FIG. 8 shows a section taken along line B-B in FIG. 6. As shown in FIGS. 2, 6, 7, and 8, the second joining portion is located near the first joining portion comprising the projecting portion 33g and the recessed portion 33h.

The end portion 33e of the first joining plate portion 33c is formed with an extended portion (a first overlapping portion) 33j extending from the end portion 33e. The extended portion 33j and the end portion (a second overlapping portion) 33f, facing the extended portion 33j, of the second joining plate portion 33d are overlapped with each other.

The extended portion 33j is part of the end portion 33e of the first joining plate portion 33c. The extended portion 33j overlaps to cover part of the end portion 33f of the second joining plate portion 33d. The extended portion 33j is formed with an opening 33m. The end portion 33f of the second joining plate portion 33d is formed with a convex caulking portion 33n.

The opening 33m has chamfered portions 33k formed so as to expand inner walls of the opening 33m on its upper edge side. The caulking portion 33n is inserted in the opening 33m. The caulking portion 33n is caulked so that it engages with the opening 33m. Thus, the extended portion 33j engages with the caulking portion 33n. Each chamfered portion 33k of the opening 33m is in the form of a tapered surface sloping planarly or a curved surface. The caulking portion 33n is formed with chamfered portions 33p on its outer side for ensuring smooth caulking at the time of caulking the caulking portion 33n to the edge sides of the opening 33m. A caulking groove 33t is formed on an upper surface in FIG. 7 of the caulking portion 33n. As shown in FIG. 8, the end portion 33f of the second joining plate portion 33d is formed with a groove 33u on its lower surface in FIG. 7 opposed to the caulking portion 33n. The groove 33u has a depth extending in a thickness direction of the end portion 33f of the second joining plate portion 33d from the lower surface in FIG. 7, opposed to the caulking portion 33n, of the end portion 33f.

The caulking portion 33n is caulked so as to be crushed to the sides of the chamfered portions 33k of the opening 33m, thereby being joined to the extended portion 33j. Therefore, the caulking portion 33n serves to improve the joining force between the end portion 33f of the second joining plate portion 33d and the extended portion 33j serving as overlapping portions cooperatively forming an overlapped and joined portion of the shell body portion 33.

The projecting portion 33g and the recessed portion 33h of the first and second joining plate portions 33c and 33d may be joined together in a reverse relationship in shape. Further, the extended portion 33j and the end portion 33f of the second joining plate portion 33d may be arranged in a reverse manner such that the caulking portion 33n is formed at the extended portion 33j while the opening 33m is formed at the end portion 33f of the second joining plate portion 33d and both are joined together in the manner as described above.

As shown in FIG. 7, a thickness T1 of the end portion 33f of the second joining plate portion 33d is set equal to the thickness of the shell body portion 33. A thickness T2 of the extended portion 33j of the first joining plate portion 33c is set smaller than the thickness T1, thereby suppressing the total thickness of the end portion 33f of the second joining plate portion 33d and the extended portion 33j.

It may be configured that the thickness of the end portion 33f of the second joining plate portion 33d shown in FIG. 7 is set to T2 and the thickness of each of the first and second joining plate portions 33c and 33d is set equal to the thickness of the shell body portion 33. Further, it may be configured that the thickness of the extended portion 33j of the first joining plate portion 33c is set smaller than T2, thereby suppressing the total thickness of the end portion 33f of the second joining plate portion 33d and the extended portion 33j.

There are a total of four contact spring portions 31a formed at the upper plate portion 33b and the first and second joining plate portions 33c and 33d of the shell 31. The contact spring portions 31a serve to ensure elastic contact with a mating shell (not shown) of the mating connector for connection thereto.

### Second Embodiment

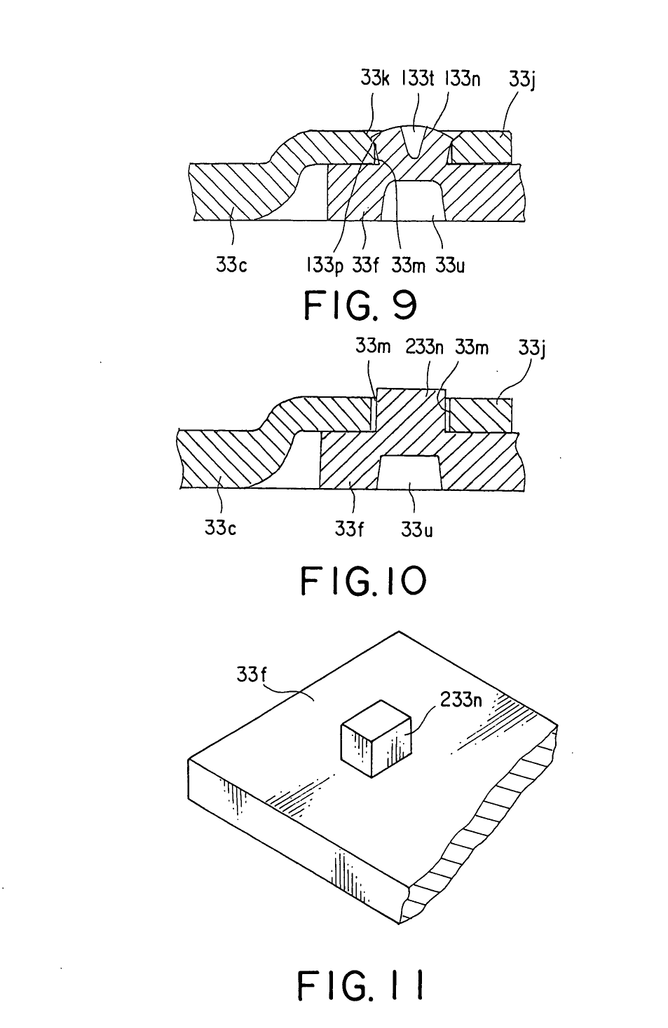

FIG. 9 shows a connector of a second embodiment according to this invention. The second embodiment includes a modification of the caulking portion 33n formed at the end portion (a second overlapping portion) 33f of the second joining plate portion 33d, which is shown in FIGS. 6 to 8 of the first embodiment.

An end portion 33f of a second joining plate portion 33d is formed with a convex caulking portion 133n. An opening 33m has chamfered portions 33k formed by expanding inner walls of the opening 33m on its upper edge side in FIG. 9.

The caulking portion 133n is inserted in the opening 33m. The caulking portion 133n is caulked at the opening 33m so that the caulking portion 133n and an extended portion 33j engage with each other.

The caulking portion 133n is formed with chamfered portions 133p on its outer side for ensuring smooth caulking at the time of caulking the caulking portion 133n to the edge sides of the opening 33m. An upper surface in FIG. 9 of the caulking portion 133n has a circular arc shape in section. A caulking groove 133t is formed on the upper surface in FIG. 9 of the caulking portion 133n. The end portion 33f of the second joining plate portion 33d is formed with a groove 33u on its lower surface in FIG. 9 opposed to the caulking portion 133n. The groove 33u has a depth extending in a thickness direction of the end portion 33f of the second joining plate portion 33d from the lower surface in FIG. 9, opposed to the caulking portion 133n, of the end portion 33f.

The caulking portion 133n is caulked so as to be crushed to the edge sides of the opening 33m in a manner to cause its upper surface in FIG. 9 to have the circular arc shape in section, thereby being joined to the extended portion 33j. Therefore, the caulking portion 133n serves to improve the joining force between the end portion 33f of the second joining plate portion 33d and the extended portion 33j serving as overlapping portions cooperatively forming an overlapped and joined portion of a shell body portion 33.

### Third Embodiment

FIGS. 10 to 12 show a connector of a third embodiment according to this invention. The third embodiment includes a modification of the caulking portion 33n formed at the end portion 33f of the second joining plate portion 33d, which is shown in FIGS. 6 to 8 of the first embodiment.

As shown in FIGS. 10 and 11, an end portion 33f of a second joining plate portion 33d is formed with a rectangular parallelepiped caulking portion 233n. The caulking portion 233n is inserted in an opening 33m formed in an extended portion (a first overlapping portion) 33j of a first joining plate portion 33c. The end portion (a second overlapping portion) 33f of the second joining plate portion 33d is formed with a groove 33u on its lower surface in FIG. 10 opposed to the caulking portion 233n. The groove 33u has a depth extending in a thickness direction of the end portion 33f from its lower surface.

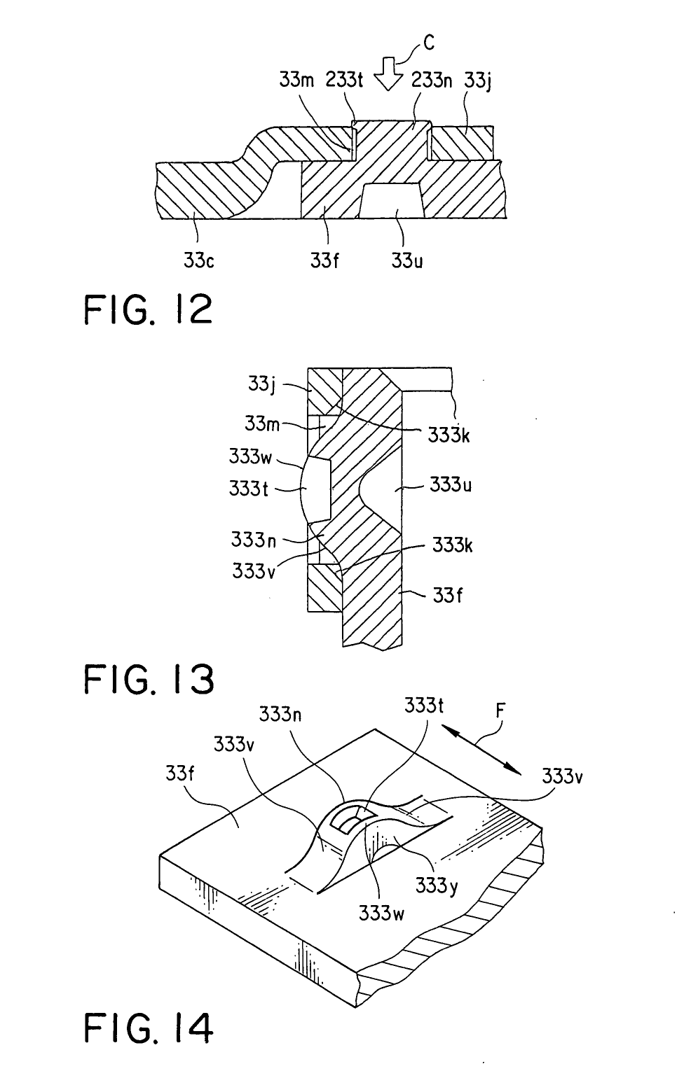

The caulking portion 233n is crushed by pressing a jig (not shown) downward against an upper surface in FIG. 12 of the caulking portion 233n in a direction indicated by an arrow C in FIG. 12. In this event, escaped portions 233t of the caulking portion 233n after the crushing move to the edge sides of the opening 33m. The opening 33m and the caulking portion 233n engage with each other. Therefore, the escaped portions 233t serve to improve the joining force between the end portion 33f of the second joining plate portion 33d and the extended portion 33j serving as overlapping portions.

### Fourth Embodiment

FIGS. 13 and 14 show a connector of a fourth embodiment according to this invention. The fourth embodiment includes a modification of the caulking portion 33n formed at the end portion 33f of the second joining plate portion 33d, which is shown in FIGS. 6 to 8 of the first embodiment. FIG. 13 shows a section taken in a direction the same as that of FIG. 8 which is taken along line B-B in FIG. 6.

As described in the first embodiment, an end portion 33e of a first joining plate portion 33c is formed with an extended portion (a first overlapping portion) 33j in a second joining portion. The extended portion 33j and an end portion (a second overlapping portion) 33f, facing the extended portion 33j, of a second joining plate portion 33d are overlapped with each other.

The extended portion 33j is part of the end portion 33e of the first joining plate portion 33c. The extended portion 33j overlaps to cover part of the end portion 33f of the second joining plate portion 33d. The extended portion 33j is formed with an opening 33m. The end portion 33f of the second joining plate portion 33d is formed with a convex caulking portion 333n projecting upward. The opening 33m has chamfered portions 333k. The chamfered portions 333k are formed by expanding inner walls, facing the caulking portion 333n, of the opening 33m on its lower edge side. The caulking portion 333n is inserted in the opening 33m. The caulking portion 333n is caulked at the opening 33m so that the caulking portion 333n and the extended portion 33j engage with each other. Each chamfered portion 333k of the opening 33m is in the form of a tapered surface sloping planarly or a curved surface formed by a tapered surface sloping with gentle curve.

An upper surface in FIG. 14 of the caulking portion 333n has a surface 333w of a circular arc shape in section and a pair of chamfered portions 333v continuous with both sides of the surface 333w. Each chamfered portion 333v is gently curved and continuous with an upper surface in FIG. 14 of the end portion 33f of the second joining plate portion 33d. That is, each chamfered portion 333v is a portion formed at the root of the caulking portion 333n. Therefore, each chamfered portion 333v is in the form of a tapered surface sloping planarly or a curved surface formed by a tapered surface sloping with gentle curve.

A caulking groove 333t is formed on the upper surface in FIG. 14 of the caulking portion 333n. The end portion 33f of the second joining plate portion 33d is formed with a groove 333u having a depth extending in a thickness direction of the end portion 33f from its lower surface in FIG. 14 opposed to the caulking portion 333n.

The caulking portion 333n is formed by, as a first process, forming two mutually parallel slits each passing through the upper and lower surfaces in FIG. 14 of the end portion 33f of the second joining plate portion 33d. In a second process, a portion, between the two slits, of the end portion 33f is pushed upward from its lower surface in FIG. 14 using a press die. In this event, plate thickness surfaces being part of sheared surfaces of the end portion 33f are exposed above the upper surface in FIG. 14 of the end portion 33f. Further, in the second process, when the caulking portion 333n is inserted into the opening 33m, the chamfered portions 333v are gently curved so as to be positioned in the opening 33m. In this event, the chamfered portions 333v are not brought into contact with the chamfered portions 333k of the opening 33m.

By caulking the caulking portion 333n in directions indicated by arrows F shown in FIG. 14, the caulking groove 333t serves to join the opening 33m and the caulking portion 333n to each other.

The caulking portion 333n serves to improve the joining force between the end portion 33f of the second joining plate portion 33d and the extended portion 33j serving as overlapping portions cooperatively forming an overlapped and joined portion of a shell body portion 33. That is, the sheared surfaces of the caulking portion 333n in the directions, indicated by the arrows F shown in FIG. 14, of opening the shell body portion 33 are maintained as they are. Further, in the caulking portion 333n, the surface perpendicular to the directions F is formed as the gently-sloping chamfered portions 333v. Therefore, the caulking portion 333n can improve the strength of the overall shell structure.

Accordingly, at the time of fitting to a mating connector, it is possible to prevent the caulking portion 333n from coming off due to deformation of a shell 31 caused by a load such as a pinch force applied to the shell 31.

In the electrical connector in each of the foregoing embodiments, the strength of the shell can be improved by providing the overlapping portions at both ends of the shell body portion and joining them together in the overlapped manner with the formation of the joining portion.

Therefore, it is possible to improve the strength of the connector against a pinch force applied to the shell at the time of the fitting.

Further, by reducing the thickness of one of both end portions of the shell and joining them together using the opening and the caulking portion at the overlapped portion, the processing of the shell can be facilitated.

The foregoing electrical connectors are also applicable to uses such as interface connectors requiring high-speed transmission and electrical connectors for EMI countermeasure.

What is claimed is:

1. An electrical connector comprising a contact, a housing holding said contact, and a shell covering said contact and said housing,
wherein said shell comprises a shell body portion and a joining portion joining both ends of said shell body portion to each other,
said joining portion comprises a first joining portion and a second joining portion,
said first joining portion comprises a projecting portion projecting from a first end portion (33e) and a recessed portion formed at a second end portion and engaging with said projecting portion,
said second joining portion comprises a first overlapping portion and a second overlapping portion that are overlapped with each other, said first overlapping portion being part of said first end portion and said second overlapping portion being part of said second end portion,
an opening is formed at one of said first and second overlapping portions and a caulking portion is formed at the other of said first and second overlapping portions, and
said caulking portion is inserted in said opening and caulked, so that said opening and said caulking portion engage with each other.

2. An electrical connector according to claim 1, wherein said first overlapping portion is an extended portion of said first end portion, said extended portion extending so as to overlap with said second end portion.

3. An electrical connector according to claim 1, wherein one of said first and second overlapping portions has a thickness smaller than that of the other of said first and second overlapping portions.

4. An electrical connector according to claim 1, wherein said opening and said caulking portion engage with each other by movement of an escaped portion of said caulking portion after crushing thereof to an edge side of said opening.

5. An electrical connector according to claim 1, wherein said opening is formed with a chamfered portion at an edge, facing said caulking portion, of said opening.

6. An electrical connector according to claim 1, wherein said caulking portion is formed with a chamfered portion on its outer side.

7. An electrical connector according to claim 1, wherein said opening has a chamfered portion formed by expanding an inner wall, facing said caulking portion, of said opening at its lower edge.

8. An electrical connector according to claim 7, wherein said chamfered portion is in the form of a tapered surface sloping planarly or a curved surface formed by a tapered surface sloping with gentle curve.

9. An electrical connector according to claim 7, wherein a chamfered portion (333v) is formed at the root of said caulking portion.

10. An electrical connector according to claim 7, wherein an upper surface of said caulking portion has a surface of a circular arc shape in section and a pair of chamfered portions continuous with both sides of said surface.
